(19) United States
(12) Patent Application Publication
(10) Pub. No.: US 2007/0191578 A1
(43) Pub. Date: Aug. 16, 2007

(54) Novel polymer compound and method for producing same

(76) Inventors: Kei Tashiro, Aichi (JP); Yasuyuki Suzuki, Aichi (JP); Seiichi Kawahara, Niigata (JP); Yoshinobu Isono, Niigata (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/591,231

(22) PCT Filed: Feb. 28, 2005
(86) PCT No.: PCT/JP05/03814

§ 371 Date: Aug. 31, 2006

(30) Foreign Application Priority Data
Mar. 1, 2004 (JP) 2004-056275

(51) Int. Cl. C08G 64/00

(52) U.S. Cl. 528/196

(57) ABSTRACT

This invention provides a novel polymeric compound having excellent gas permeability, oil resistance, stability, and molding proccessability and a method for producing the same. The novel polymeric compound is a cyclic carbonate-containing polymeric compound represented by formula (I).

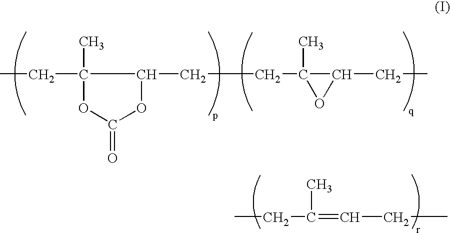

### TECHNICAL FIELD

The present invention relates to a novel substance with excellent physical properties and a method for producing the same.

### BACKGROUND ART

Natural rubber is superior in mechanical properties necessary for rubbery materials, such as tensile strength, tear strength, and tackiness, which are well-balanced in use; however, it is inferior in gas permeability and oil resistance. Since natural rubber does not have any polar group, the affinity between the rubber and a polymer having a polar group, such as polyvinyl chloride, chloroprene rubber, or acrylonitrile-butadiene rubber, is poor. When an adhesive and a natural rubber blend are prepared therefrom, accordingly, materials to be blended with natural rubber are disadvantageously limited.

In order to overcome such drawbacks, gas permeability and oil resistance are imparted to natural rubber while maintaining its excellent mechanical properties and film-forming abilities via epoxidation thereof. Since epoxidized natural rubber has a polar group, it can be likely compatible with the polymer having the polar group.

However, a ring opening of the epoxy group in epoxidized natural rubber results in intermolecular crosslinks to form gel fraction. This becomes more significant particularly when epoxidized natural rubber is degraded into liquid form. Thus, less stability and poor molding proccessability are disadvantage for epoxidized natural rubber.

JP Patent Publication (Kokai) No. 2002-53573 A is a prior art document related to the invention according to the present application. JP Patent Publication (Kokai) No. 2002-53573 A discloses a method for producing alkylene carbonate wherein alkylene oxide having an epoxy group is allowed to react with supercritical carbon dioxide.

### DISCLOSURE OF THE INVENTION

An object of the present invention is to overcome the detrimental properties of epoxidized natural rubber while maintaining the outstanding properties. More particularly, the present invention is directed to providing a novel polymeric compound having excellent gas permeability, oil resistance, stability, and molding proccessability and a method for producing the same.

(1) A cyclic carbonate-containing polymeric compound represented by formula (I): 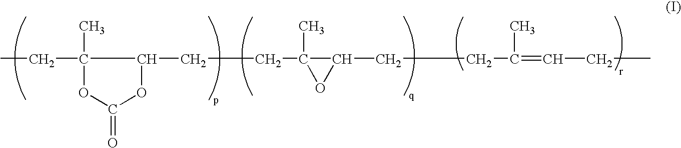
wherein p, q, and r independently represent the molar composition ratio of each monomer unit: p is a number over 0; q and r are each a number not smaller than 0; and the sum of p, q, and r is 1 or smaller.

(2) A method for producing the cyclic carbonate-containing polymeric compound according to (1) comprising a first step of epoxidizing natural rubber and a second step of allowing the epoxidized natural rubber obtained via the first step to react with supercritical carbon dioxide.

(3) The method according to (2), wherein the second step is carried out in the presence of a polar organic solvent and/or an ionic liquid.

(4) The method according to (3), wherein the polar organic solvent is at least one member selected from the group consisting of N,N-dimethylformamide, N,N-diethylformamide, N,N-dimethylacetamide, N,N-diethylacetamide, and N-methylpyrrolidone.

(5) The method according to (3), wherein the ionic liquid is at least one member selected from the group consisting of 3-methyl-1-octylimidazolium tetrafluoroborate, 1-hexyl-3-methylimidazolium tetrafluoroborate, 1-butyl-3-methylimidazolium tetrafluoroborate, 1-ethyl-3-methylimidazolium tetrafluoroborate, 1-ethyl-3-methylimidazolium hexafluorophosphate, and 1-ethyl-3-methylimidazolium trifluoromethanesulfate.

(6) The method according to any of (2) to (5), wherein the second step is carried out at a reaction temperature between 50° C. and 200° C.

(7) The method according to any of (2) to (6), wherein the second step is carried out at a supercritical carbon dioxide pressure of between 5 MPa and 20 MPa.

(8) The method according to any of (2) to (7), wherein the second step is carried out for 0.5 hour to 20 hours.

The present invention provides a novel polymeric compound having excellent gas permeability, oil resistance, stability, and molding proccessability and a method for producing the same.

This specification includes part or all of the contents as disclosed in the specifications of Japanese Patent application No. 2004-56275, which are the base of the priority claim of the present application.

### BRIEF DESCRIPTION OF THE DRAWING

FIG. 1 shows the infrared absorption spectra of commercialized propylene carbonate, those of the product attained in Example 1 (the carbonated, liquefied, epoxidized, and deproteinized natural rubber latex), and those of natural rubber latex in that order from the top to the bottom.

FIG. 2A shows the ¹H-NMR spectra of commercialized propylene carbonate, those of the product attained in Example 2 (cyclic-carbonated natural rubber), and those of liquid epoxidized natural rubber in that order from the top to the bottom. FIG. 2B shows the ¹H-NMR spectral assignment of propylene carbonate. FIG. 2C shows the ¹H-NMR spectral assignment of cyclic-carbonated natural rubber and those of liquid epoxidized natural rubber.

FIG. 3A shows the ¹³C-NMR spectra of commercialized propylene carbonate, those of the product attained in Example 2 (cyclic-carbonated natural rubber), and those of liquid epoxidized natural rubber in that order from the top to the bottom. FIG. 3B shows the ¹³C-NMR spectral assignment of propylene carbonate. FIG. 3C shows the ¹³C-NMR spectral assignment of cyclic-carbonated natural rubber and those of liquid epoxidized natural rubber.

FIG. 4 shows the ¹³C/¹H-shift-correlated NMR spectra of the product attained in Example 2 (cyclic-carbonated natural rubber).

### PREFERRED EMBODIMENT OF THE INVENTION

Hereafter, the present invention is described in detail.

The present invention relates to a novel cyclic carbonate-containing polymeric compound represented by formula (I): 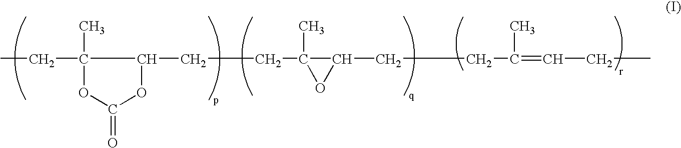
wherein p, q, and r independently represent the molar composition ratio of each monomer unit: p is a number over 0; q and r are each a number not smaller than 0; and the sum of p, q, and r is 1 or smaller. In formula (I), the sum of p, q, and r is preferably 1. The degree of polymerization of the aforementioned polymeric compound is preferably between 2 and 100,000, more preferably between 10 and 10,000, and most preferably between 10 and 2,000.

In formula (I), the monomer unit represented by 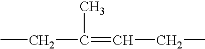
may be a cis or trans form. A cis form and a trans form may be present together in a single molecule of the polymeric compound represented by formula (I).

The aforementioned polymeric compound may be a block copolymer or a random copolymer. When the polymeric compound is produced from natural rubber in accordance with the method of production according to the present invention described below, the product is generally a random copolymer.

Since the polymeric compound according to the present invention contains carbonate that is a stable polar group, crosslinking between polymers is less likely to occur and a gel is less likely to be formed. Accordingly, the polymeric compound according to the present invention has better stability and molding proccessability than conventional epoxidized natural rubber. Also, the polymeric compound according to the present invention has gas permeability and oil resistance that are equivalent to those of conventional epoxidized natural rubber. Since the polarity of a carbonate group is equivalent to that of an epoxy group, the polymeric compound according to the present invention can be freely used in combination with a polymer having a polar group. Further, the polymeric compound according to the present invention is expected to exhibit ionic conductivity and optical anisotropic properties. Patent Document 1 mentioned above simply discloses a technique of converting an epoxy group in alkylene oxide to a carbonate group. This patent document, however, does not mention that the polymeric compound having carbonate according to the present invention exhibits the aforementioned advantageous effects.

There is a possibility that the polymeric compound according to the present invention has ionic conductivity. Thus, there is a possibility that combination of the polymeric compound according to the present invention with one or more electrolytic salts results in the production of a polymeric electrolyte. Electrolytic salts may be adequately selected in accordance with the applications of the polymeric electrolyte. Examples thereof that can be used include all types of lithium salts such as lithium bis-(trifluoromethanesulfonyl)imide (LiTFSI) and lithium peroxide (LiClO₄). Such polymeric electrolyte may further comprise a non-aqueous solvent. A non-aqueous solvent may be adequately selected in accordance with the applications of the polymeric electrolyte. Examples thereof that can be used include ethylene carbonate and propylene carbonate. The polymeric electrolyte, thus obtained, is expected to exhibit high ionic conductivity and excellent molding proccessability at room temperature.

The aforementioned compound is produced by the method comprising a first step of epoxidizing natural rubber or natural rubber that had been adequately processed (e.g., via vulcanization or deproteinization) and a second step of bringing the epoxidized natural rubber obtained via the first step into contact with supercritical carbon dioxide to allow them to react. Thus, the compound according to the present invention can be produced from biomass, i.e., natural rubber. Also, the use of supercritical carbon dioxide can result in reducing quantities of metal catalysts used, wastewater disposal of which is difficult. Accordingly, the compound according to the present invention is preferable from the viewpoint of protection of the natural environment. During the growth stage of a rubber tree, carbon dioxide in the air is absorbed and carbon dioxide is further absorbed by natural rubber derived from a rubber tree according to the present invention. Thus, the present invention is also preferable from the viewpoint of absorption of carbon dioxide in the air, which is a cause for global warming.

In the present invention, the term “natural rubber” is used in a general sense. For example, it refers to, but is not limited to, natural rubber latex, raw rubber obtained via solidification and dehydration of natural rubber latex with a conventional technique, or vulcanized rubber obtained via vulcanization of raw rubber with a conventional technique. Natural rubber is mainly composed of polyisoprene and contains minor amounts of resin, protein, and ash. At least some of the double bonds in the main chain of natural rubber are epoxidized, and the epoxidized natural rubber is brought into contact with supercritical carbon dioxide to allow them to react. Thus, a reaction mixture mainly composed of a novel cyclic carbonate-containing polymeric compound represented by formula (I) can be obtained. The mixture, thus obtained, can additionally comprise very small amounts of other ingredients (e.g., protein). It has functions equivalent to those of the compound represented by formula (I) and can be employed for similar applications without further purification. If necessary, it can be adequately purified.

In the present invention, the phrase “epoxidizing natural rubber” refers to a procedure of epoxidizing at least some of the double bonds in the main chain of natural rubber. The aforementioned first step can also be carried out by common epoxidation techniques, such as a method involving the use of an epoxidation agent such as performic acid or peracetic acid (generally prepared from hydrogen peroxide and formic acid or acetic acid in advance) or a method involving the use of hydrogen peroxide in the presence of a catalyst (e.g., osmium salt or tungstic acid) and a solvent.

The degree of epoxidation attained by the first step is preferably 1 to 100 molar percent, more preferably 20 to 100 molar percent, and most preferably 50 to 100 molar percent.

Subsequently, the second step wherein the epoxidized natural rubber obtained in the first step is brought into contact with supercritical carbon dioxide is carried out to convert the epoxy group introduced in the first step to a cyclic carbonate group.

The second step is preferably carried out in the presence of a polar organic solvent and/or an ionic liquid. Examples of a polar organic solvent that can be used include: N,N-dimethylformamide, N,N-diethylformamide, N,N-dimethylacetamide, and N,N-diethylacetamide, which have amide groups; N-methylpyrrolidone; tetramethylurea or N,N-dimethylethyleneurea; and dimethylsulfoxide having a sulfinyl group. Among them, N,N-dimethylformamide, N,N-diethylformamide, N,N-dimethylacetamide, N,N-diethylacetamide, and N-methylpyrrolidone are particularly preferable. Preferred examples of an ionic liquid that can be used include 3-methyl-1-octylimidazolium tetrafluoroborate, 1-hexyl-3-methylimidazolium tetrafluoroborate, 1-butyl-3-methylimidazolium tetrafluoroborate, 1-ethyl-3-methylimidazolium tetrafluoroborate, 1-ethyl-3-methylimidazolium hexafluorophosphate, and 1-ethyl-3-methylimidazolium trifluoromethanesulfate. The use of a polar organic solvent and/or an ionic liquid is preferable since it allows introduction of a cyclic carbonate group to be advanced without the use of a metal catalyst, the wastewater disposal of which is difficult.

The second step is preferably carried out at a reaction temperature between 50° C. and 200° C., and more preferably between 90° C. and 180° C. When the reaction temperature is within this range, cleavage of the main chain of epoxidized natural rubber is inhibited and a ring opening of an epoxy group is selectively advanced. Thus, carbonation with carbon dioxide is selectively advanced.

In the second step, a carbon dioxide pressure is preferably in the range of 5 MPa to 25 MPa, more preferably in the range of 5 MPa to 20 MPa, and most preferably in the range of 5 MPa to 15 MPa. When the reaction pressure is within this range, the carbon dioxide concentration is sufficiently high. Thus, carbonation with carbon dioxide advances upon the ring opening of an epoxy group, which makes side reactions difficult to advance.

In the second step, the reaction duration is preferably for 0.5 hour to 20 hours. When the reaction duration is within this range, carbonation between an epoxy group and carbon dioxide sufficiently advances and side reactions are less likely to advance.

Further, natural rubber that is used as a starting material in the present invention is preferably subjected to deproteinization prior to the first step for epoxidation. The novel polymeric compound according to the present invention, which is produced with the use of deproteinized natural rubber, does not have the distinctive odor of natural rubber and does not experience discoloration due to oxidation of remaining proteins. Accordingly, the use thereof for daily-used products such as supplies and nursing care goods, and for goods to be exposed to others, is preferable. Also, the use thereof for goods that are to be in contact with a human body is preferable since there is no possibility that immediate allergy would be caused by remaining proteins. Further, the novel polymeric compound according to the present invention that is produced with the use of deproteinized natural rubber is highly stable and preferable since it does not comprise any non-rubber components that could cause side reactions during storage. A method for deproteinizing natural rubber is not particularly limited. An example thereof that can be employed is a method wherein a proteinase such as alkali protease and a surfactant are added to natural rubber latex to carry out proteolysis and the latex is then thoroughly washed via centrifugation or other means (see JP Patent Publication (Kokai) No. 6-56902 A (1994)). As described in the Examples, an alternative method, wherein a surfactant is added to natural rubber latex, a protein-denaturing agent is added to denature a protein, and the denatured protein is then removed, thereby substantially completely deproteinizing natural rubber latex, can be employed.

In the method for producing the polymeric compound according to the present invention, natural rubber as a starting material or epoxidized natural rubber as an intermediate may be liquefied. For example, the polymeric compound according to the present invention can be produced by a method wherein natural rubber is liquefied via depolymerization by a conventional technique, the resulting liquefied natural rubber is epoxidized (the first step), and the resulting liquid epoxidized natural rubber is carbonated (the second step). Alternatively, a method wherein natural rubber is epoxidized (the first step), the resulting epoxidized natural rubber is liquefied via depolymerization, and the resulting liquid epoxidized natural rubber is carbonated (the second step) can also be employed.

According to an embodiment of the present invention, the method involving the use of deproteinized natural rubber may be employed in combination with the method involving liquefaction of the polymeric compound.

### EXAMPLE 1

Production of the Compound Represented by Formula (I)

(i) Deproteinization of Natural Rubber Latex

As a starting material, natural rubber latex that had not been treated with ammonia was used after 2 days had passed following sampling from a rubber tree, and the latex was diluted to adjust the rubber component to 30% by weight. Sodium lauryl sulfate (SLS, an anionic surfactant, 1.0 part by weight) was added to 100 parts by weight of the rubber components of the latex for stabilization. Subsequently, 0.2 parts by weight of urea was added to 100 parts by weight of the rubber component of the latex as a denaturing agent, and the mixture was allowed to stand at 60° C. for 60 minutes for denaturation.

The denatured latex was subjected to centrifugation at 13,000 rpm for 30 minutes. The thus separated cream layer at the top was dispersed in an aqueous solution of 1% by weight surfactant to result in a rubber component concentration of 30% by weight, and the second centrifugation was similarly carried out. Further, the resulting cream was redispersed in the aqueous solution of 1% by weight surfactant to obtain deproteinized natural rubber latex.

The nitrogen content of this deproteinized natural rubber latex was 0.004% by weight and the allergen concentration was 1.0 μg/ml. The nitrogen content was measured by the RRIM method (the Rubber Research Institute of Malaysia, 1973, SMR Bulletin No. 7). The allergen concentration was measured by the LEAP method (abbreviation for “Latex ELISA for Allergenic Protein”).

(ii) Epoxidation of Deproteinized Natural Rubber Latex

Sodium dodecyl sulfate (1.5% by weight) was added to 100 g of the deproteinized natural rubber latex obtained in (i) to adjust the pH level to 5. An aqueous solution of 33 v/v % peracetic acid (50 ml) was added thereto and the resultant was agitated at 5° C. to 10° C. for 3 hours.

After the completion of the reaction, the pH level was adjusted to 7 and 150 ml of epoxidized and deproteinized natural rubber latex was obtained. The degree of epoxidation was 56%. The degree of epoxidation was measured by ¹H-NMR assay.

(iii) Liquefaction of Epoxidized and Deproteinized Natural Rubber Latex

A portion (100 ml) of the epoxidized and deproteinized natural rubber latex obtained in (ii) was separated, the pH level thereof was adjusted to 8, 1 phr (abbreviation for “parts per hundred rubber”; the amount per 100 parts by weight of the rubber component) of ammonium persulfate and 15 phr of propanal were added thereto and mixed, and the resulting mixture was then shaken at 65° C. for 10 hours.

After the completion of the reaction, the sample was solidified with the aid of methanol, methanol was removed via decantation, the sample was dissolved in toluene, and the resultant was reprecipitated in methanol. Such reprecipitation was repeated three times and 6.5 g of liquefied, epoxidized, and deproteinized natural rubber latex was obtained.

(iv) Preparation of the Compound of the Present Invention

The liquefied, epoxidized, and deproteinized natural rubber latex obtained in (iii) (1.5 g, degree of epoxidation: 56%) was placed in an SUS-316 reaction vessel having a sapphire window (volume: 100 ml) together with 48.5 g of N,N-dimethylformamide (DMF) (the molar ratio relative to the liquefied, epoxidized, and deproteinized natural rubber latex was 66.4:1), the content of the reaction vessel was heated at 120° C., carbon dioxide was introduced to set the pressure at 8 MPa, and reaction was carried out for 5 hours. After the reaction, the reaction vessel was cooled and depressurized.

Subsequently, reprecipitation and purification were carried out with the aid of toluene-methanol to obtain 0.85 g of the product.

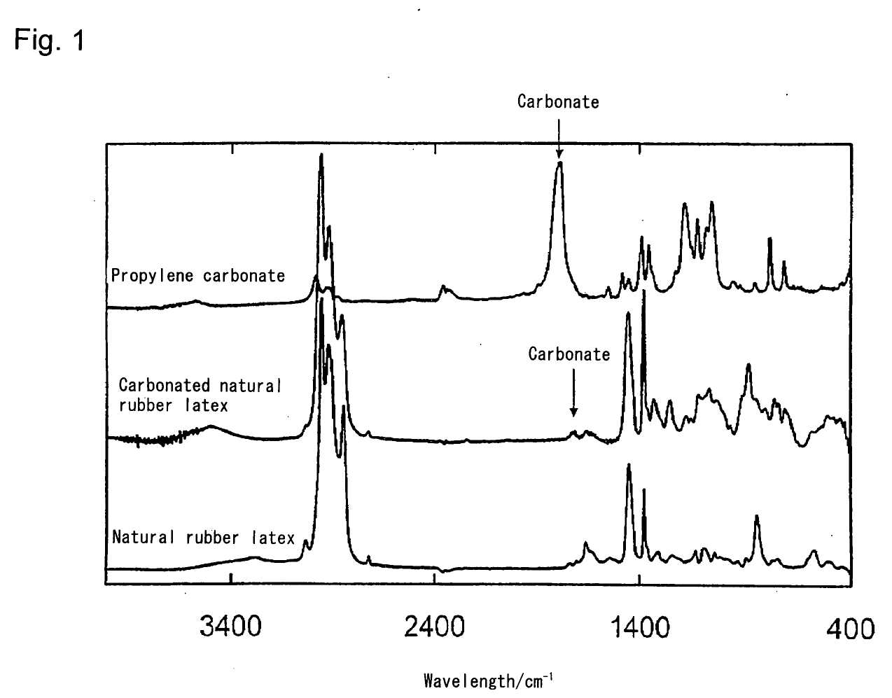

FIG. 1 shows the infrared absorption spectra (IR spectra) of the product. For comparison, the IR spectra of commercialized propylene carbonate (Tokyo Kasei Kogyo Co., Ltd.) and that of natural rubber latex are also shown. As for the product attained in the present example, more significant peak resulting from the stretching vibration (C=0) is shown at around 1,700 cm⁻¹ than that of natural rubber latex as a starting material. This indicates that a carbonate group is introduced by the method described in the present example.

Accordingly, the carbonated, liquefied, epoxidized, and deproteinized natural rubber latex according to the present invention became a chemically stable compound via introduction of a carbonate group. Thus, it can be said that the compound according to the present invention has excellent molding proccessability.

### EXAMPLE 2

Liquid epoxidized natural rubber was allowed to react with supercritical carbon dioxide in the presence of an LiBr catalyst at 130° C. and 20 MPa for 6 hours. Thus, cyclic, carbonated, liquefied, and epoxidized natural rubber was obtained (this is referred to as “cyclic-carbonated natural rubber”).

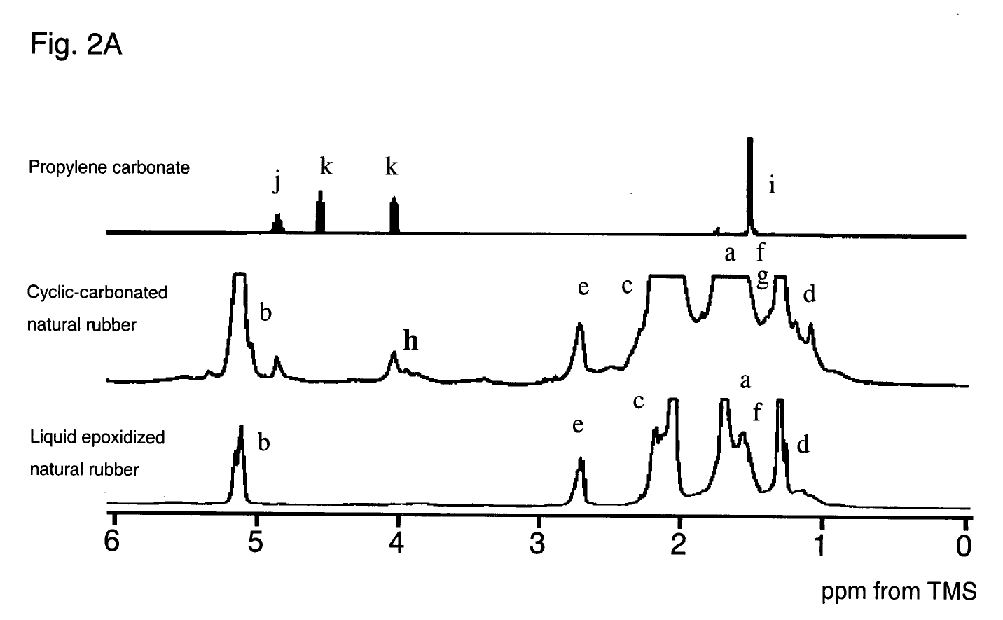

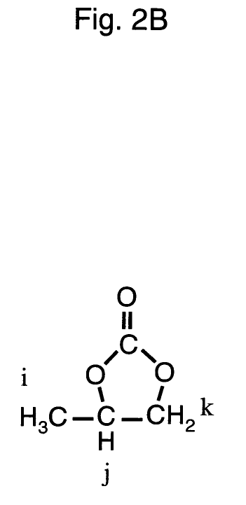

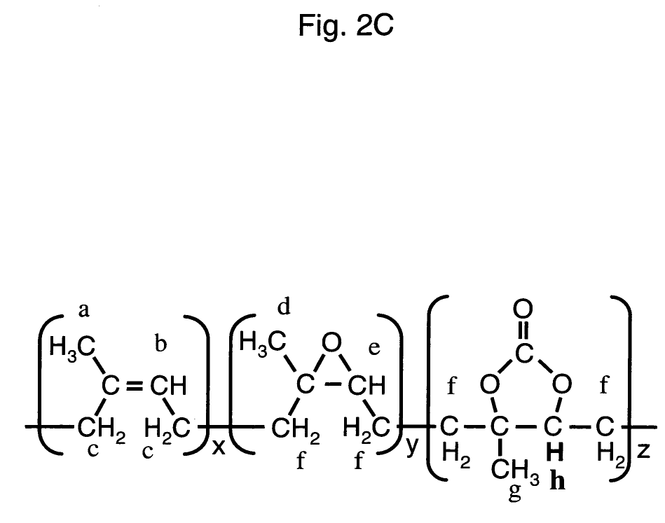

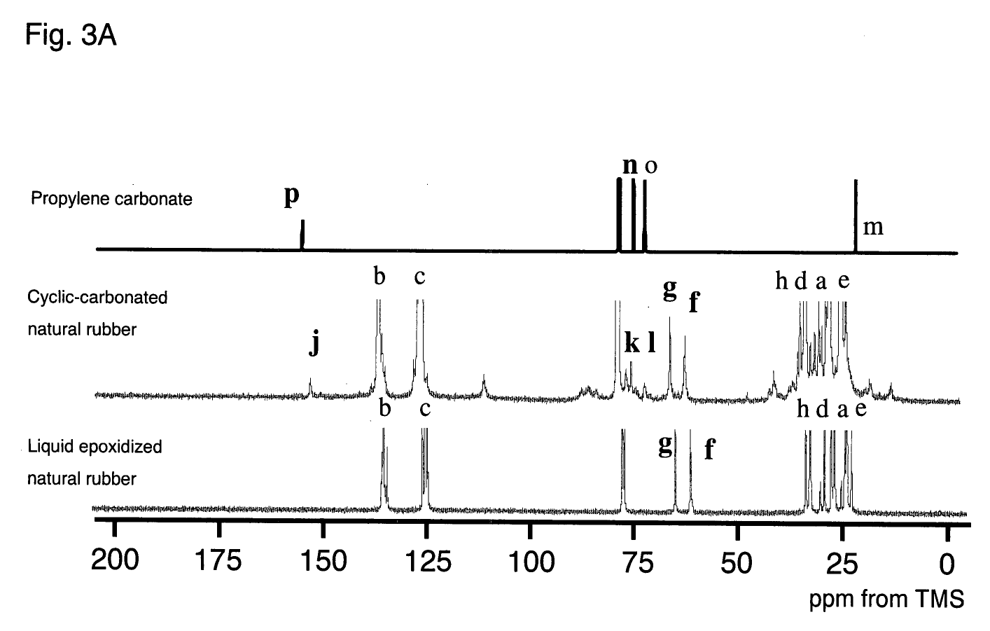

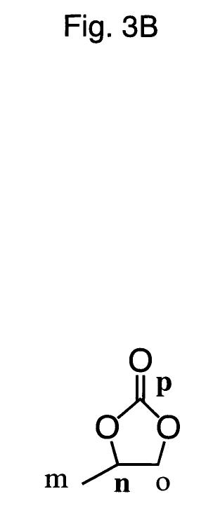

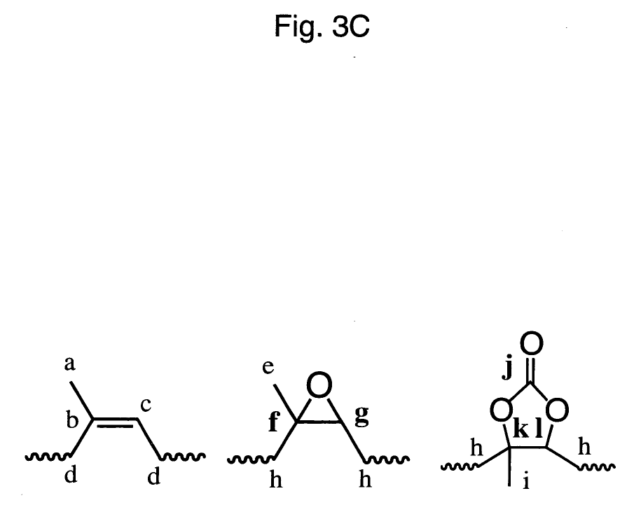

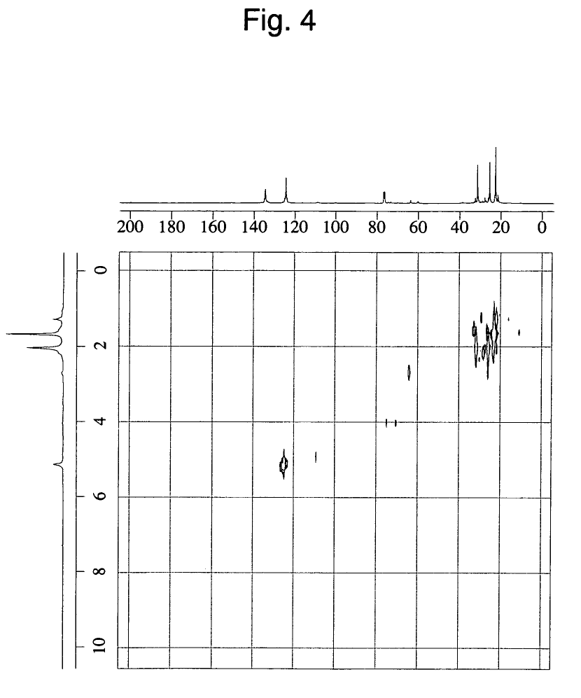

FIG. 2 shows the ¹H-NMR spectra of liquid epoxidized natural rubber, those of cyclic-carbonated natural rubber, and those of propylene carbonate as a reference compound. A new signal appeared at around 4.0 ppm in the product generated via the reaction with supercritical carbon dioxide. Also, a signal that was peculiar to a carbonate group appeared at around 3.5 ppm to 5.5 ppm in the ¹H-NMR spectra of the reference compound propylene carbonate. FIG. 3 shows the ¹³C-NMR spectra of liquid epoxidized natural rubber, those of cyclic-carbonated natural rubber, and those of propylene carbonate. Two signals appeared at around 61 ppm and 64 ppm in the spectra of liquid epoxidized natural rubber. Such signals were assigned to methine and quaternary carbons of the epoxy group in accordance with the previous report (W. Klinkai, S. Kawahara, T. Mizuno, M. Yoshizawa, J. T. Sakdapipaniel, Y. Isono, H. Ohno, Eur. Polym. J., 39, 1707-1712 (2003)). When natural rubber was cyclic-carbonated, signals appeared at around 74 ppm, 75 ppm, and 150 ppm, and signals at 61 ppm and 64 ppm were reduced. Based on the spectra of the reference compound propylene carbonate, signals at 74 ppm, 75 ppm, and 151 ppm were assigned to methine and quaternary carbons of the cyclic carbonate group. Based on the signals at around 74 ppm, 75 ppm, and 151 ppm, cyclic-carbonation of natural rubber was found to have been advanced via the reaction between liquid epoxidized natural rubber and supercritical carbon dioxide. FIG. 4 shows the ¹³C/¹H-shift correlated spectra of cyclic-carbonated natural rubber. The ¹³C signal of the cis-1,4-isoprene unit was found to be correlated with the ¹H signal corresponding thereto. Further, the signal at around 75 ppm originated from the methine group of the cyclic carbonate group was correlated with the ¹H signal at around 4.0 ppm. Thus, the signals at 75 ppm and at 4.0 ppm shown in the ¹³C-NMR and ¹H-NMR were assigned to the methine carbon and the methine proton of the cyclic carbonate group.

### INDUSTRIAL APPLICABILITY

The present invention provides a novel polymeric compound having excellent gas permeability, oil resistance, stability, and molding proccessability and a method for producing the same.

All the publications, patents and patent applications cited herein are incorporated herein by reference in their entirely.

1. A cyclic carbonate-containing polymeric compound represented by formula (I): 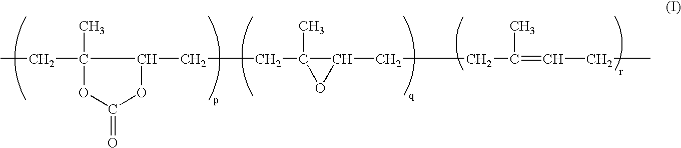
wherein p, q, and r independently represent the molar composition ratio of each monomer unit: p is a number over 0; q and r are each a number not smaller than 0; and the sum of p, q, and r is 1 or smaller.

2. A method for producing the cyclic carbonate-containing polymeric compound according to claim 1 comprising a first step of epoxidizing natural rubber and a second step of allowing the epoxidized natural rubber obtained via the first step to react with supercritical carbon dioxide.

3. The method according to claim 2, wherein the second step is carried out in the presence of a polar organic solvent and/or an ionic liquid.

4. The method according to claim 3, wherein the polar organic solvent is at least one member selected from the group consisting of N,N-dimethylformamide, N,N-diethylformamide, N,N-dimethylacetamide, N,N-diethylacetamide, and N-methylpyrrolidone.

5. The method according to claim 3, wherein the ionic liquid is at least one member selected from the group consisting of 3-methyl-1-octylimidazolium tetrafluoroborate, 1-hexyl-3-methylimidazolium tetrafluoroborate, 1-butyl-3-methylimidazolium tetrafluoroborate, 1-ethyl-3-methylimidazolium tetrafluoroborate, 1-ethyl-3-methylimidazolium hexafluorophosphate, and 1-ethyl-3-methylimidazolium trifluoromethanesulfate.

6. The method according to claim 2, wherein the second step is carried out at a reaction temperature between 50° C. and 200° C.

7. The method according to claim 2, wherein the second step is carried out at a supercritical carbon dioxide pressure of between 5 MPa and 20 MPa.

8. The method according to claim 2, wherein the second step is carried out for 0.5 hour to 20 hours.
